(19) United States
(12) Patent Application Publication
(10) Pub. No.: US 2005/0050120 A1
(43) Pub. Date: Mar. 3, 2005

(54) Method of developing a fast algorithm for double precision shift operation

(76) Inventor: Yang-Ming Shih, Hsinchu (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/652,822

(22) Filed: Aug. 29, 2003

(51) Int. Cl. G06F 7/00

(52) U.S. Cl. 708/209

(57) ABSTRACT

A method of developing a fast algorithm for a double precision shift operation is disclosed. The proposed shift operation only requires two instruction cycles, by which the first instruction calls for shifting out of a predetermined number of bits of a first operand at a first memory location into a shift register; and then the second instruction calls for shifting of the same number of bits of a second operand at a second memory location, and then performing a logical OR operation with the shifted operand and the overflow data in the shift register, and finally storing the operation result to the second memory location. As such, the proposed algorithm is able to reduce the number of instructions needed as compared with conventional methods, thus the overall efficiency of the data operation can be greatly improved.

### BACKGROUND OF THE INVENTION

1. Field of the Invention

The present invention relates to a method of developing a fast algorithm for a double precision shift operation, in particular to a method of developing a machine executable algorithm for a double precision shift operation using only two instruction cycles.

2. Description of Related Arts

Older 16-bit processors can only perform a single precision (16-bit) shift operation. Although a 16-bit processor equipped with a barrel shifter can perform a cyclic shifting operation for a word in length of 1-15 bits by a single instruction, it cannot finish a double precision (32-bit) operation with a single instruction. Since the architecture and design of each processor is a little different, the memory addressing technique for each one is also different. If the same double precision algorithm is ported to a different processor, it is not surprising to find that the other processor may not use the same number of instructions with the same operation process. For example, for a processor that only performs a register-to-register operation, a total of nine machine instructions are required to perform a double precision shift operation, and those instructions are listed below (assuming that the data is stored in memory location 0X20 and 0X21, where the most significant bit (MSB) is at 0X20 and the least significant bit (LSB) is at 0X21).

| Machine instruction | Function of the named operation |
|---|---|
| MOV R0, M(0X20) | Reading data from memory location (0X20) and |
| | passing it to shift register R0; |
| MOV R1, M(0X21) | Reading data from memory location(0X21) and |
| | passing it to shift register R1; |
| MOV R2, R1 | Copying the data from register R1 to register R2; |
| SL R1, #6 | Shifting the content of register R1 to the left by |
| | 6 bits; |
| SL R0, #6 | Shifting the content of register R0 to the left by |
| | 6 bits; |
| SR R2, #(16 − 6) | Shifting the content of register R2 to the right by |
| | 10 bits (16 − 6 = 10); |
| OR R0, R2 | Taking the data in registers R0 and R2 for OR |
| | operation and then storing the operation result to |
| | register R0; |
| MOV M(0X20), R0 | Reading data from register R0 and writing it to |
| | memory location (0X20); |
| MOV M(0X21), R1 | Reading data from register R1 and writing it to |
| | memory location (0X21). |

The sequence of operation for the nine machine instructions required for the shift operation is shown in FIG. 2. The operation of shifting a double precision number to the left by 6 bits takes nine machine instructions, mainly due to two reasons:

1. the processor does not have a direct memory operation capability; and

2. the processor does not have shift registers.

Assuming a processor without the above problems, that mean the processor has a direct memory addressing capability and the shift registers, then the shift operation on the double precision number can be reduced to three instruction cycles.

| Machine instructions | Function of the named instruction |
|---|---|
| SL M(0X20), #6 | Shifting data at memory location (0X20) to the |
| | left by 6 bits; |
| SL M(0X21), #6 | Shifting data at memory location (0X21) to the |
| | left by 6 bits and shifting the overflow 6 bits into |
| | a shift register; |
| OR M(0X20), SB | Taking the shifted data at memory location |
| | (0X20) and the content of the shift register for OR |
| | operation and then storing it in memory |
| | location (0X20). |

The above mentioned instruction steps are found on the most efficient processor executable algorithm for a double precision shift operation, among all the double precision shifting algorithms currently available.

However, from the standpoint of the present invention, the total number of instructions for a double precision shift operation can be further reduced for maximum efficiency.

### SUMMARY OF THE INVENTION

The main object of the present invention is to provide a fast algorithm for double precision shift operation that can be executed by a processor (MCU) with two instruction cycles. Comparing with the one previously claimed to be the most efficient algorithm, the efficiency of the double precision shift operation under the present invention can be further improved by 33%.

To this end, the steps necessary to realize a fast algorithm for a double precision shift operation include:

a first instruction to shift a predetermined number of bits of a first operand at a first memory location, and then to shift the overflow bits into a shift register; and

a second instruction to shift the same number of bits of a second operand at a second memory location, and then to take the shifted operand at the second memory location and the overflow data in the shift register for a logical OR operation, and finally to store the operation result to the second memory location.

The above-mentioned instructions each take a single instruction to finish, and in accordance with the present invention, that means the shift operation can be successfully completed with two instruction cycles.

The features and structure of the present invention will be more clearly understood when taken in conjunction with the accompanying drawings.

### BRIEF DESCRIPTION OF THE DRAWINGS

FIG. 1 is a diagram of the shift operation of the present invention, showing the direction of movement of the overflow bits; and

FIG. 2 is a diagram of the shift operation by a conventional processor.

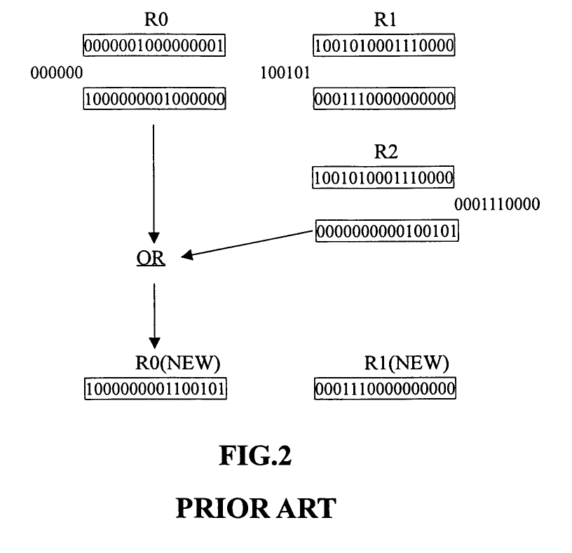

### DETAILED DESCRIPTION OF THE PREFERRED EMBODIMENT

The present invention provides a method of developing a fast algorithm for a double precision shift operation that can be executed by a processor (MCU) with two instruction cycles. However, there is a pre-condition to the above claim that is the given processor (MCU) can only execute a single instruction within one instruction cycle, unlike some processors with multi-functional units or some high performance digital signal processors that can put two or more op code in a single instruction.

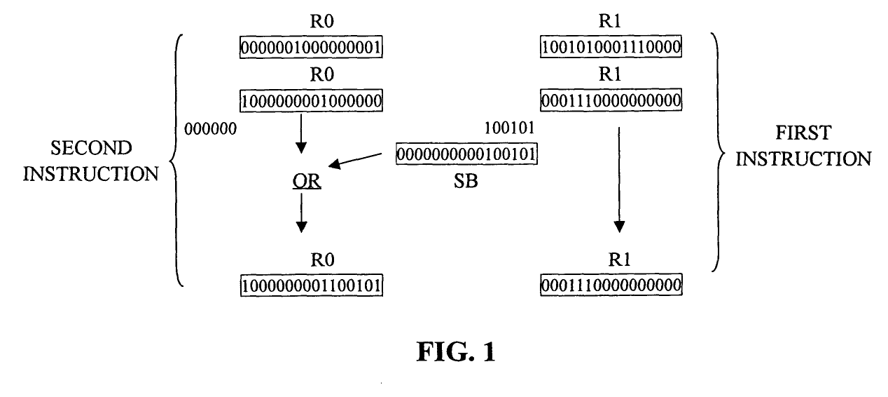

The fast algorithm for a double precision shift operation can be executed by a single-instruction processor with two instruction cycles, as shown in FIG. 1, wherein the first instruction calls for shifting of a predetermined number of bits in a first operand at a first memory location to the left (the most significant bit MSB), and then shifting of the overflow bits into a shift register; and

the second instruction calls for shifting of the same number of bits of a second operand at a second memory location (the least significant bit LSB), and then taking the shifted second operand and the overflow data in the shift register for a logical OR operation, and then restoring the operation result to the second memory location.

This fast algorithm is not only designed for left shift operation, but also for right shift operation. In a right shift operation, the first operand at the first memory location called by the first instruction becomes the most significant bit (MSB), whilst the second operand at the second memory location called by the second instruction becomes the least significant bit (LSB).

The first instruction is equivalent to an SL or SR instruction in the standard instruction set, but the second instruction cannot find an equivalent. Therefore, a new instruction SLORSB or SRORSB has to be added to the existing instruction set. The function of the new instruction includes performing an OR operation with the shifted operand and the overflow data in the shift register, and storing the operation result to the original memory location.

The following machine instructions are actually employed in an implementation, in the same sequence as listed out:

| Machine instruction | Function of the named instruction |
|---|---|
| SL M(0X21), #6 | shifting the first operand at a memory location |
| | (0X21) to the left by 6 bits, and shifting out the |
| | overflow bits into a shift register; |
| SLORSB M(OX20), #6 | Shifting the second operand at memory location |
| | (0X21) to the left by 6 bits, and then taking the |
| | shifted operand at the above memory location |
| | and the overflow data in the shift register for a |
| | logical OR operation, and finally storing the |
| | operation result to the memory location (0X20). |

In summary, with the addition of the SLORSB and SRORSB instructions, the fast algorithm for double precision operand shift operation, in accordance with the present invention, can be executed by a single-instruction processor with two instruction cycles. Since the shift register and OR gate are standard elements in the processor configuration, only the instruction decoder has to be slightly modified to include the new instructions SLORSB and SRORSB in the instruction set, and the related control circuitry has to be partially modified. However, the efficiency of the double precision shift operation can be improved by 33% after such modifications.

The foregoing description of the preferred embodiments of the present invention is intended to be illustrative only and, under no circumstances, should the scope of the present invention be so restricted.

1. A method of developing a fast algorithm for a double precision shift operation that can be executed by a processor using a first instruction and a second instruction, wherein
the first instruction calls for shifting of a first operand at a first memory location to the left a predetermined number of bits, and then shifting out the overflow bits into a shift register; and
the second instruction calls for shifting of the same number of bits of a second operand at a second memory location, and then taking the shifted operand at the second memory location and the overflow data in the shift register for a logical OR operation, and then storing the operation result to the second memory location.

2. The method of developing a fast algorithm as claimed in claim 1, wherein the first instruction is equivalent to an SL or SR instruction in the standard instruction set.

3. The method of developing a fast algorithm as claimed in claim 1, where in a left shift operation the first operand at the first memory location called by the first instruction becomes the least significant bit (LSB); whilst the second operand at the second memory location called by the second instruction becomes the most significant bit (MSB).

4. The method of developing a fast algorithm as claimed in claim 2, where in a left shift operation the first operand at the first memory location called by the first instruction becomes the least significant bit (LSB); whilst the second operand at the second memory location called by the second instruction becomes the most significant bit (MSB).

5. The method of developing a fast algorithm as claimed in claim 1, where in a right shift operation the first operand at the first memory location called by the first instruction becomes the most significant bit (MSB); whilst the second operand at the second memory location called by the second instruction becomes the least significant bit (LSB).

6. The method of developing a fast algorithm as claimed in claim 2, where in a right shift operation the first operand at the first memory location called by the first instruction becomes the most significant bit (MSB); whilst the second operand at the second memory location called by the second instruction becomes the least significant bit (LSB).
